(19) United States
(12) Patent Application Publication
(10) Pub. No.: US 2012/0101768 A1
(43) Pub. Date: Apr. 26, 2012

(54) DIAGNOSIS OF STATOR THERMAL ANOMALIES IN AN ELECTRICAL MACHINE

(75) Inventors: Binu Mathew Moonjanattu, Bangalore (IN); Vasudev Shankar Nilajkar, Bangalore (IN); Sudhanshu Rai, Bangalore (IN)

(73) Assignee: GENERAL ELECTRIC COMPANY, Schenectady, NY (US)

(21) Appl. No.: 12/911,993

(22) Filed: Oct. 26, 2010

(51) Int. Cl. G01K 13/00

(52) U.S. Cl. 702/132; 702/183

(57) ABSTRACT

A system, method and computer program for diagnosing thermal anomalies in a stator of an electrical machine. A first system is provided that includes an input system for obtaining RTD readings over time from at least one sensor in a stator winding; a normalization system for normalizing each RTD reading with respect to armature current; and an analysis system for analyzing a trend in a set of normalized RTD readings to indicate thermal behavior of the stator winding. A second system is provided that includes an input system for obtaining a set of RTD readings from a plurality of sensors in a common axial location in a stator winding; a calculation system for calculating a difference value between a maximum value and a median value from the set of RTD readings; and an analysis system for analyzing a trend over time in a set of difference values to indicate thermal behavior of the stator winding.

### BACKGROUND OF THE INVENTION

The present invention relates generally to diagnosing thermal anomalies in stator windings in an electrical machine such as a generator, and more particularly to using resistance temperature detectors (RTDs) to diagnose thermal anomalies in stator windings.

Thermal anomalies in the stator windings of a generator can occur for any number of reasons, e.g., excessive vibration, inadequate cooling, etc. The result of such anomolies can lead to insulation failure of the windings. This may lead to excessive heating in the region and result in a stator ground fault, which can be costly to address. The inability to diagnose and avoid stator ground faults at an early stage often exascerbates the severity of damage and time of outage.

### BRIEF DESCRIPTION OF THE INVENTION

In one aspect of the invention, a system for evaluating thermal behavior in an electrical machine is provided, comprising: as input system for obtaining RTD readings over time from at least one sensor in a stator winding; a normalization system for normalizing each RTD reading with respect to armature current; and an analysis system for analyzing a trend in a set of normalized RTD readings to indicate thermal behavior of the stator winding.

In another aspect of the present invention, a system for evaluating thermal behavior in an electrical machine is provided, comprising: an input system for obtaining a set of resistance temperature detector (RTD) readings from a plurality of sensors in a common axial location in a stator winding; a calculation system for calculating a difference value between a maximum value and a median value from the set of RTD readings; and an analysis system for analyzing a trend over time in a set of difference values to indicate thermal behavior of the stator winding.

In a further aspect, a computer program comprising program code embodied in at least one computer-readable storage medium is provided, which when executed, enables a computer system to implement a method of evaluating thermal behavior in an electrical machine, the method comprising: obtaining resistance temperature detector (RTD) readings over time from at least one sensor in a stator winding; normalizing each RTD reading with respect to armature current; and analyzing a trend in a set of normalized RTD readings to indicate thermal behavior of the stator winding.

### BRIEF DESCRIPTION OF THE DRAWINGS

FIG. 1 is a schematic diagram of a computer system having a diagnosis system according to one embodiment of the invention;

FIG. 2 is a schematic block diagram of a process for evaluating thermal anomalies according to one embodiment of the present invention;

FIG. 3 shows a graph illustrating detection of a thermal anomaly according to one embodiment of the present invention;

FIG. 4 is a schematic block diagram of a process for evaluating thermal anomalies according to a second embodiment of the present invention;

FIG. 5 depicts a plan view of a generator according to one illustrative embodiment of the present invention; and

FIG. 6 depicts and a sectional view of the generator of FIG. 5 in which three RTDs reside along a common axial plane AA′.

### DETAILED DESCRIPTION OF THE INVENTION

Various embodiments of the present invention are directed to evaluating and diagnosing thermal anomalies in stator windings using resistance temperature detectors (RTDs). Technical effects of the various embodiments of the present invention include the ability to identify thermal anomalies at an early stage, thus providing the capability of avoiding costly outages associated with stator wire ground faults. Additional technical effects include the ability to evaluate and trend thermal behaviors of the winding, and to provide an alarm if a predefined threshold is exceeded.

Electrical machines such as generators generate heat as a result of current passing through the windings. Cooling mechanisms are incorporated into generators to address the heat issues and RTDs are commonly utilized to ensure that the temperature of the generator, and particularly the stator windings, is below allowable limits.

Embodiments of the invention utilize RTDs to evaluate thermal behaviors in the winding and identify thermal anomalies at an early stage. The temperature monitored by each RTD is generally proportional to the amount of current passing through it, the resistivity of the windings and the ambient temperature. By analyzing trends within the RTD data, anomalies can be identified.

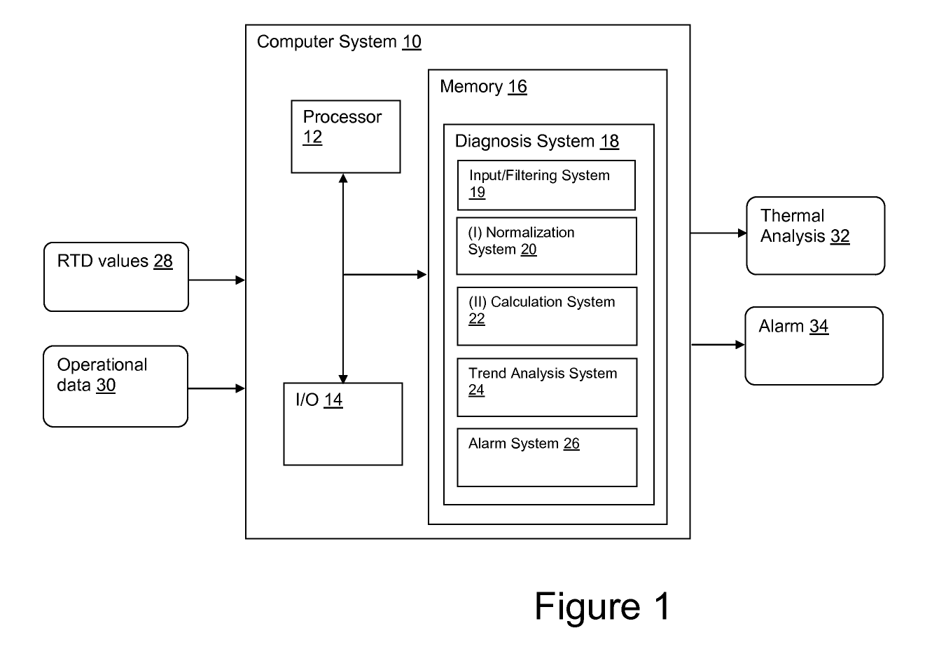

FIG. 1 depicts a computer system 10 having a diagnosis system 18 for implementing two possible approaches for detecting anomalies in stator windings based on RTD values 28 and other operational data 30. A first approach provided by diagnosis system 18 utilizes a normalization system 20 for normalizing RTD values 28 with respect to current and resistivity at a corresponding ambient temperature. A second approach utilizes a calculation system 22 that determines a difference of a maximum value and a median value for a set of axially located RTDs. It is understood that either or both approaches may be included and/or utilized within diagnosis system 18. Diagnosis system 18 further includes: an input/filtering system 19 for obtaining and filtering RTD values 28 and operational data 30; a trend analysis system 24 for evaluating trends over time and providing a thermal analysis 32; and an alarm system 26 for issuing an alarm 34 if a winding anomaly is detected. The two approaches are described in more detail below.

In the first approach, changes in RTD values are normalized with respect to current and resistivity at the corresponding ambient temperature. In general, normalization refers to the division of multiple sets of data by one or more common variables in order to negate that variables' effect on the data, thus allowing underlying characteristics of the data sets to be compared. This thus this allows data on different scales to be compared, by bringing them to a common scale. When normalized, rising RTD values result in a constant output for an electrical machine running under consistent operating conditions (i.e., constant operating pressure and coolant properties). Trending of normalized RTD values are thus used to indicate thermal behavior of the windings. For example, an increasing (i.e., positive) trend indicates an anomaly in the windings. An alarm may be generated if the increasing trend exceeds a configurable parameter (e.g., a 15% increase) for a predefined amount of time (e.g., 10 hours).

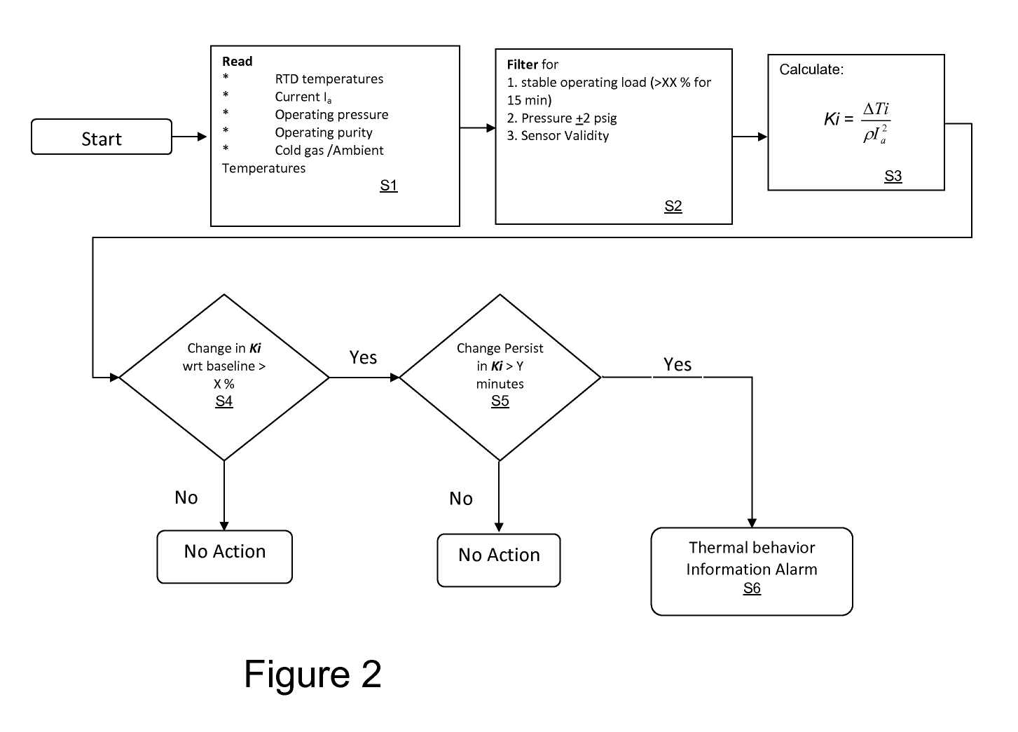

FIG. 2 depicts a flow diagram of this first approach. At S1, input/filtering system 19 reads RTD temperatures Ti from sensors i at various locations within the stator windings. In addition, armature current Iₐ, operating pressure, operating purity and cold gas/ambient temperatures are read by input/filtering system 19 using known sensors within the unit. At S2, data points are filtered to ensure: a stable operating load (e.g., load>XX % for 15 minutes); pressure +/−2 psig; and sensor readings deemed valid. At S3, normalization system 20 calculates normalized RTD values Ki for the different locations, e.g., at the turbine end (i=1), at the compressor end (i=2), and at the center (i=3) according to the equation:

$$Ki = \frac{Δ Ti}{ρ {I}_{a}^{2}}$$

where ΔTi is a difference between the RTD temperature and the ambient temperature, ρ is the resistivity of the windings and Iₐ is the armature current.

Next, at S4, trend analysis system 24 makes a determination whether Ki has changed more than a predetermined percent with respect to a baseline value. The baseline value for the normalized temperature may for example be calculated as a one-month average of the temperature rise. If no significant change is detected, i.e., no at S4, then no action is taken since no anomaly is indicated. If a change is detected, then at S5 trend analysis system makes a determination whether the change persists in Ki for more than some predetermined amount of time. If the change does not persist, i.e., no at S5, then no action is taken. If yes, then at S6, an anomaly is indicated and alarm system 26 generates a thermal anomaly information alarm 34.

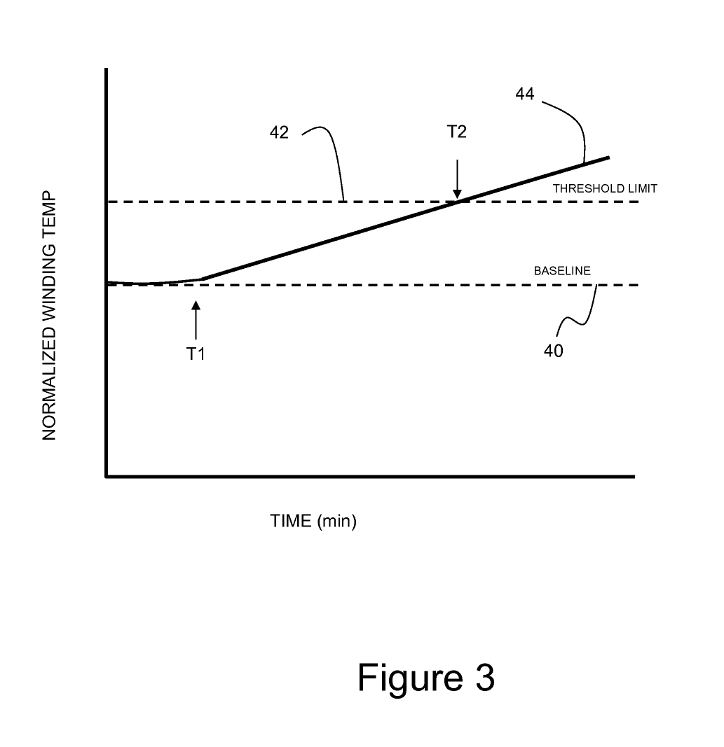

FIG. 3 depicts an illustrative trend analysis involving normalized winding temperatures. In this example, a baseline value 40 is established, as well as a threshold limit 42. A normalized RTD value 44 is tracked over time and at a time T1 the normalized RTD value 44 begins to deviate from the base value 40. At T2, the normalized RTD value 44 crosses the threshold limit 42, indicating that an anomaly may exist.

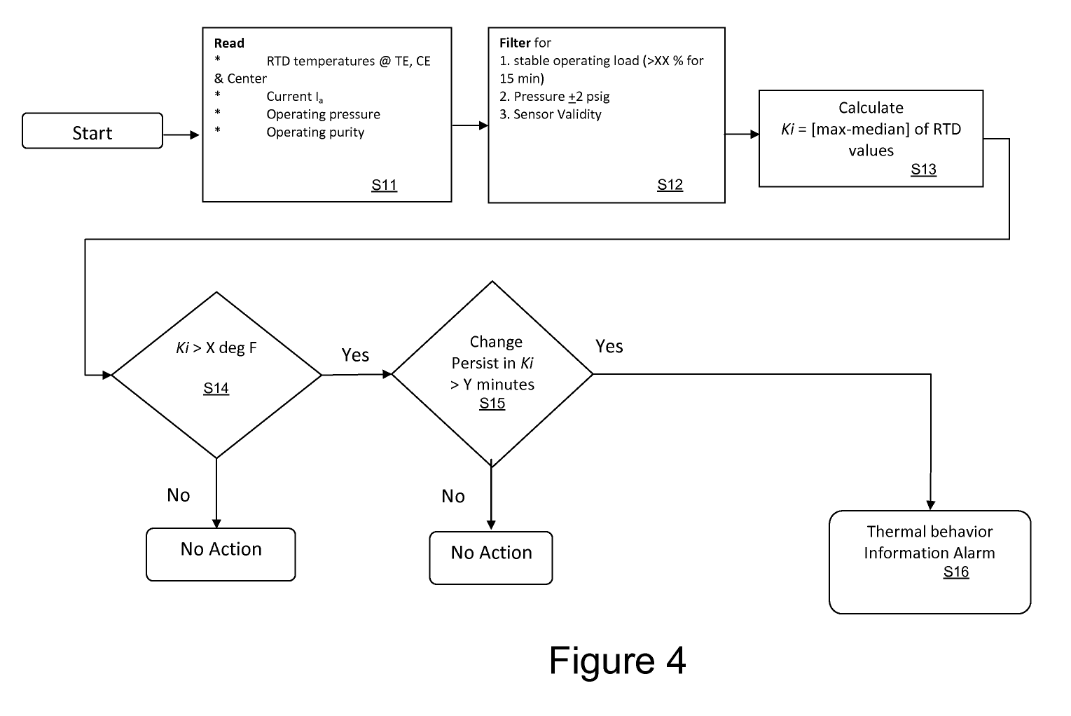

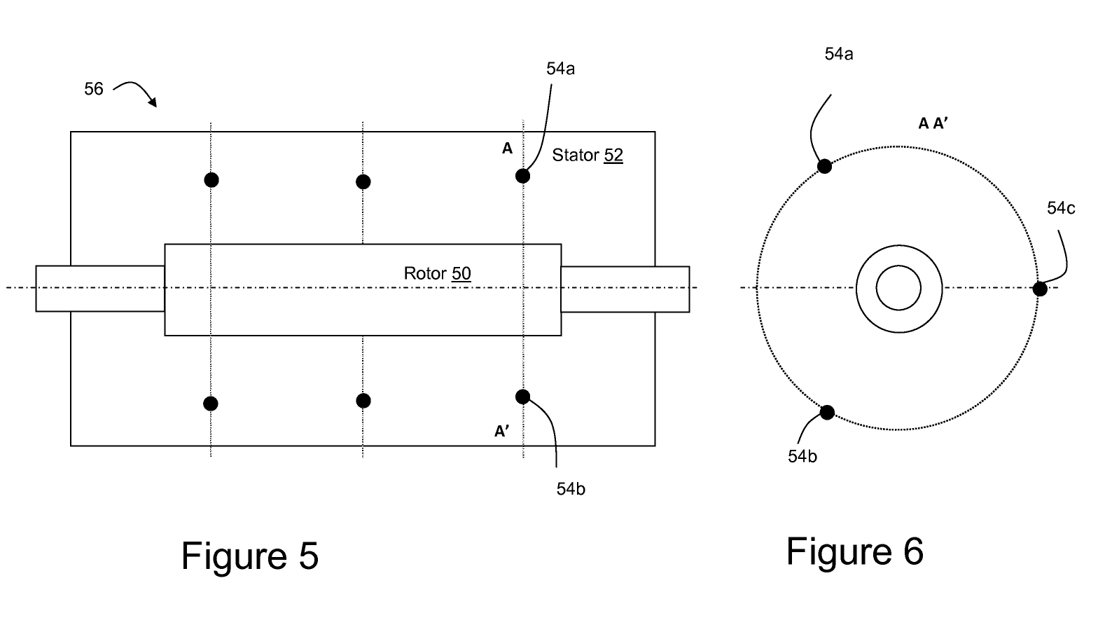

FIG. 4 depicts a flow diagram of the second approach utilizing a difference value that is the difference of a maximum RTD value and a median RTD value for any set of commonly located axially RTDs. For example, FIGS. 5 and 6 depict a generator 56 in a plan view and a sectional view cut along AA′. In this example, three RTDs 54a, 54b, 54c reside along the common axial plane AA′. The difference of the maximum value and the median value of RTDs 54 are trended at a particular range of currents for an electrical machine. If there is any anomaly in the windings, the trend will have a positive slope. An alarm can be issued if for example the increasing trend exceeds a predefined threshold (e.g., 10 degrees C.) for a predefined amount of time (e.g., 10 hours). Note in this case, three RTDs 54a, 54b, 54c are utilized. However, it is understood that any number (i.e., two or more) of RTDs could be utilized.

Referring again to FIG. 4, an illustrative algorithm is provided. At S11, input/filtering system 19 reads RTD temperatures Ti for at least two RTDs in a common axial location, e.g., plane. In addition, armature current Iₐ, operating pressure, and operating purity are also read by system 19 from appropriate sensors. At S2, system 19 filters data points for: a stable operating load (e.g., load>XX % for 15 minutes); pressure +/−2 psig; and sensor validity. At S13, calculation system 22 calculates a difference value Ki as the difference of a maximum value and median value of the RTD values along the common axial plane. Next at S14, trend analysis system makes a determination whether Ki is greater than a predetermined temperature. If no at S14, no action is taken. If yes, a determination is made at S15 whether the change detected at S14 persists for more than a predetermined amount of time. If no at S15, then no action is taken. If yes, then alarm system 26 may generate a thermal behavior information alarm at S16.

In both approaches, the inputting and filtering done by input/filtering system 29 may be implemented as a single function or separate functions. Accordingly, although shown as a single function, it is understood that inputting and filtering may be done separately. One of the filtering processes may include checking the validity of the RTD sensors. This may be done, e.g., by:
(1) checking whether the RTD sensor displays a temperature that exceeds the maximum allowable limits (e.g., 150 deg C);
(2) checking whether the RTD sensor displays a temperature lower than the ambient temperature during standard operations of the electric generator;
(3) checking whether RTD values are flat (e.g., if the standard deviation is very low);
(4) checking whether the RTD sensor displays a fluctuating value over a configurable limit for any given current (or if the standard deviation is high);
(5) checking whether the RTD sensor displays a positive or negative trend for a considerable amount of time during machine shut down;
(6) checking whether a set of RTDs placed at any axial location/space show a temperature higher than a configurable limit for a given current.

In various embodiments of the present invention, aspects of the systems and methods described herein can be implemented in the form of an entirely hardware embodiment, an entirely software embodiment or an embodiment containing both hardware and software elements. In one embodiment, the processing functions may be implemented in software, which includes but is not limited to firmware, resident software, microcode, etc.

Furthermore, the processing functions can take the form of a computer program product accessible from a computer-usable or computer-readable medium providing program code for use by or in connection with a computer or any instruction execution system (e.g., processing units). For the purposes of this description, a computer-usable or computer readable medium can be any computer readable storage medium that can contain or store the program for use by or in connection with the computer, instruction execution system, apparatus. Additional embodiments may be embodied on a computer readable transmission medium (or a propagation medium) that can communicate, propagate or transport the program for use by or in connection with the computer, instruction execution system, apparatus, or device.

The computer readable medium can be an electronic, magnetic, optical, electromagnetic, infrared, or semiconductor system (or apparatus or device). Examples of a computer-readable medium include a semiconductor or solid state memory, a random access memory (RAM), a read-only memory (ROM), a rigid magnetic disk and an optical disk. Current examples of optical disks include a compact disk—read only memory (CD-ROM), a compact disk—read/write (CD-R/W) and a digital video disc (DVD).

In any event, computer system 10 (FIG. 1) can comprise one or more general purpose computing articles of manufacture (e.g., computing devices) capable of executing program code installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, diagnosis system 18 can be embodied as any combination of system software and/or application software. In any event, the technical effect of computer system 10 is to evaluate and diagnose thermal anomalies in stator windings.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the disclosure has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the disclosure.

What is claimed is:

1. A system for evaluating thermal behavior in an electrical machine, comprising:
an input system for obtaining resistance temperature detector (RTD) readings over time from at least one sensor in a stator winding;
a normalization system for normalizing each RTD reading with respect to armature current; and
an analysis system for analyzing a trend in a set of normalized RTD readings to indicate thermal behavior of the stator winding.

2. The system of claim 1, wherein the analysis system indicates an anomaly in response to detecting an increasing trend.

3. The system of claim 2, wherein the analysis system detects the increasing trend when an RTD reading increase exceeds a baseline value by a predetermined amount.

4. The system of claim 3, wherein the analysis system detects the increasing trend when the RTD reading increase persists for longer than a predetermined amount of time.

5. The system of claim 1, wherein the input system further obtains an armature current, operating pressure, operating purity, and ambient temperature.

6. The system of claim 1, further comprising a filter system that ensures input data is collected by a valid sensor, during a stable operating load, and at a predefined pressure range.

7. The system of claim 1, wherein the normalization system calculates a normalized RTD value Ki for a sensor i using the equation:
$$Ki = \frac{Δ Ti}{ρ {I}_{a}^{2}}$$
where ΔTi is a difference between an RTD temperature and an ambient temperature, ρ is a resistivity of the stator winding and Iₐ is an armature current.

8. A system for evaluating thermal behavior in an electrical machine, comprising:
an input system for obtaining a set of resistance temperature detector (RTD) readings from a plurality of sensors in a common axial location in a stator winding;
a calculation system for calculating a difference value between a maximum value and a median value from the set of RTD readings; and
an analysis system for analyzing a trend over time in a set of difference values to indicate thermal behavior of the stator winding.

9. The system of claim 8, wherein the analysis system indicates an anomaly in response to detecting an increasing trend.

10. The system of claim 9, wherein the analysis system detects the increasing trend when an increased difference value exceeds a baseline value by a predetermined amount.

11. The system of claim 10, wherein the analysis system detects the increasing trend when the increased difference value persisting for longer than a predetermined amount of time.

12. The system of claim 8, wherein the input system further obtains an armature current, operating pressure, and operating purity.

13. The system of claim 8, further comprising a filter system that ensures input data is collected by a valid sensor, during a stable operating load, and at a predefined pressure range.

14. A computer program comprising program code embodied in at least one computer-readable storage medium, which when executed, enables a computer system to implement a method of evaluating thermal behavior in an electrical machine, the method comprising:
obtaining resistance temperature detector (RTD) readings over time from at least one sensor in a stator winding;
normalizing each RTD reading with respect to armature current; and
analyzing a trend in a set of normalized RTD readings to indicate thermal behavior of the stator winding.

15. The computer program of claim 14, wherein the analyzing indicates an anomaly in response to detecting an increasing trend.

16. The computer program of claim 15, wherein the analyzing detects the increasing trend when an RTD reading increase exceeds a baseline value by a predetermined amount.

17. The computer program of claim 16, wherein the analyzing detects the increasing trend when the RTD reading increase persists for longer than a predetermined amount of time.

18. The computer program of claim 14, further comprising obtaining an armature current, operating pressure, operating purity, and ambient temperature.

19. The computer program of claim 14, further comprising ensuring input data is collected by a valid sensor, during a stable operating load, and at a predefined pressure range.

20. The computer program of claim 14, wherein a normalized RTD value Ki for a sensor i is calculated using the equation:
$$Ki = \frac{Δ Ti}{ρ {I}_{a}^{2}}$$
where ΔTi is a difference between an RTD temperature and an ambient temperature, ρ is a resistivity of the stator winding and Iₐ is an armature current.
